(19) United States
(12) Patent Application Publication
(10) Pub. No.: US 2005/0207276 A1
(43) Pub. Date: Sep. 22, 2005

(54) Egg beater

(76) Inventors: Shun-Xing Xu, Ping Dong Hsien (TW); Yu-Chang Xu, Ping Dong Hsien (TW); Yu-Ting Xu, Ping Dong Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/805,911

(22) Filed: Mar. 22, 2004

(51) Int. Cl. B01F 13/00

(52) U.S. Cl. 366/343

(57) ABSTRACT

An egg beater includes a seat, and a stirring net mounted on the seat and including a plurality of primary stirring strips and a plurality of secondary stirring strips. Each of the primary stirring strips has a surface formed with a helical groove. Thus, the air is introduced into the dough rapidly and largely by guide of the helical grooves of the primary stirring strips during rotation of the stirring net, so that the air input introduced into the dough is greatly enhanced, thereby decreasing the stirring time of the egg beater.

### BACKGROUND OF THE INVENTION

1. Field of the Invention

The present invention relates to an egg beater, and more particularly to an egg beater, wherein the air is introduced into the dough rapidly and largely by guide of the helical grooves of the primary stirring strips during rotation of the stirring net, so that the air input introduced into the dough is greatly enhanced, thereby decreasing the stirring time of the egg beater.

2. Description of the Related Art

A conventional egg beater 3 in accordance with the prior art shown in FIGS. 1 and 2 is mounted on a motorized mixer. The motorized mixer comprises a frame 1 having an inside provided with an electric power (not shown), a mixing barrel 2 mounted on the frame 1 for placing dough and liquid egg (not shown), and a rotation shaft 11 mounted on the frame 1 for driving the conventional egg beater 3 to rotate. The conventional egg beater 3 includes a seat 31, a mounting portion 33 mounted on a first side of the seat 31 and combined with the rotation shaft 11, and a stirring net 32 mounted on a second side of the seat 31. The stirring net 32 includes a plurality of primary stirring strips 321 and a plurality of secondary stirring strips 322. In operation, the conventional egg beater 3 is rotated by the rotation shaft 11, so that the stirring net 32 is rotated to stir and mix the dough and liquid egg in the mixing barrel 2 by the primary stirring strips 321 and the secondary stirring strips 322. Thus, the stirring net 32 is rotated successively to stir and shear the dough to introduce the air into the dough so as to mix the dough with the air, thereby forming a loose and soft product for further proceedings. However, the air is introduced into the dough by rotation of the stirring net 32 only, so that the air input introduced into the dough is limited and is not large enough, thereby increasing the stirring time, and thereby decreasing the quality of the product.

### SUMMARY OF THE INVENTION

The primary objective of the present invention is to provide an egg beater, wherein the air is introduced into the dough rapidly and largely by guide of the helical grooves of the primary stirring strips during rotation of the stirring net, so that the air input introduced into the dough is greatly enhanced, thereby decreasing the stirring time of the egg beater.

Another objective of the present invention is to provide an egg beater, wherein the air is completely introduced into the dough by guide of the helical grooves of the primary stirring strips, thereby increasing the quality of the blank product.

A further objective of the present invention is to provide an egg beater, wherein the helical grooves of the primary stirring strips shear the dough during rotation of the stirring net, so that the dough is sheared smoothly and completely, thereby increasing the quality of the cake product made of the blank product.

A further objective of the present invention is to provide an egg beater, wherein the primary stirring strips have overlapping portions closely combined with each other by soldering, so that the primary stirring strips are combined with rigidly and stably, thereby increasing the lifetime of the egg beater.

In accordance with the present invention, there is provided an egg beater, comprising a seat, and a stirring net mounted on the seat and including a plurality of primary stirring strips and a plurality of secondary stirring strips, wherein:
each of the primary stirring strips has a surface formed with a helical groove.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional egg beater for a motorized mixer in accordance with the prior art;

FIG. 2 is a perspective view of the conventional egg beater in accordance with the prior art;

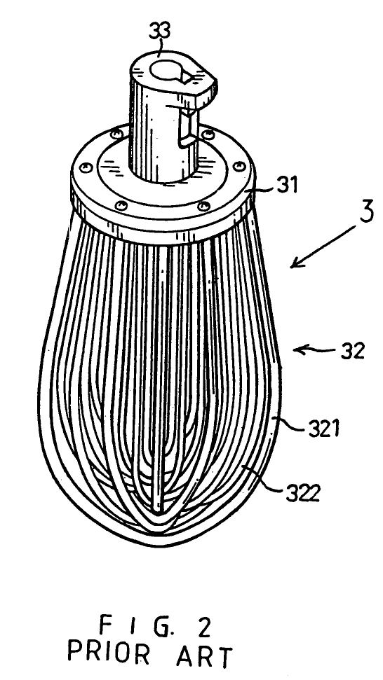

FIG. 3 is a perspective view of an egg beater in accordance with the preferred embodiment of the present invention;

FIG. 4 is a plan cross-sectional view of the egg beater as shown in FIG. 3; and

FIG. 5 is a partially cut-away enlarged plan view of the egg beater as shown in FIG. 4.

### DETAILED DESCRIPTION OF THE INVENTION

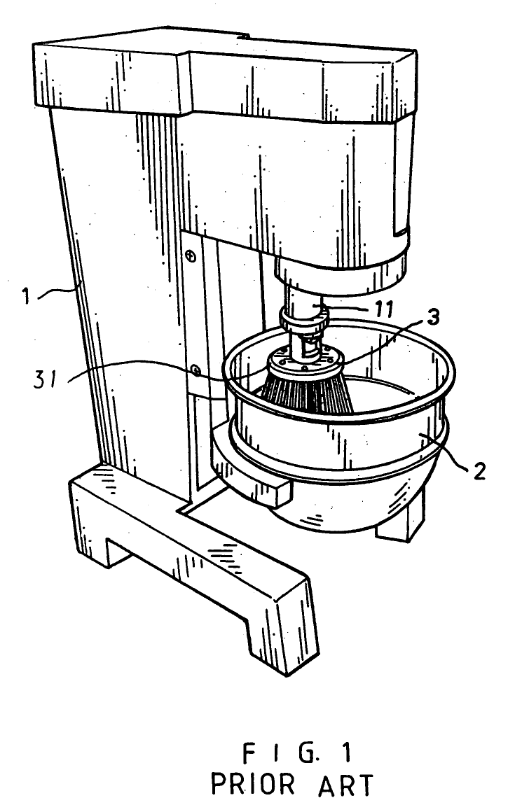

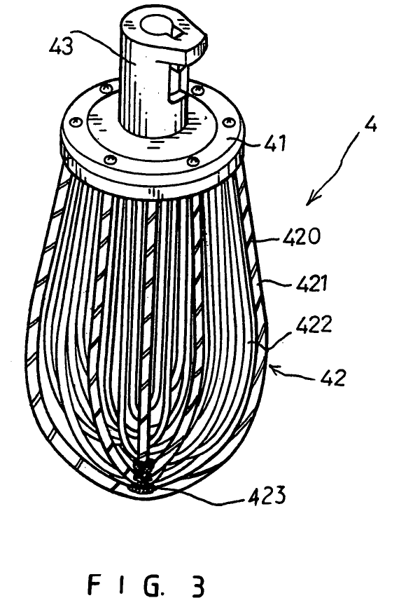

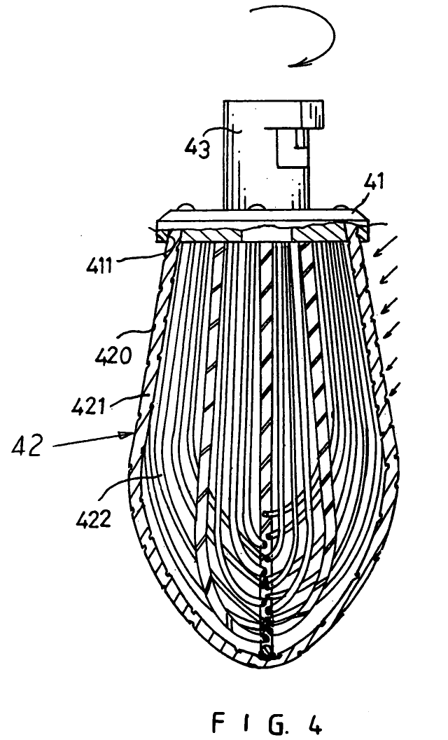

Referring to the drawings and initially to FIGS. 3 and 4, an egg beater 4 in accordance with the preferred embodiment of the present invention comprises a circular seat 41, a mounting portion 43 mounted on a first side of the seat 41 and combined with the rotation shaft 11 as shown in FIG. 1, and a barrel-shaped stirring net 42 mounted on a second side of the seat 41. The stirring net 42 includes a plurality of primary stirring strips 421 and a plurality of secondary stirring strips 422. The seat 41 has a periphery formed with a plurality of mounting holes 411 (see-FIG. 4) for mounting the primary stirring strips 421 and the secondary stirring strips 422.

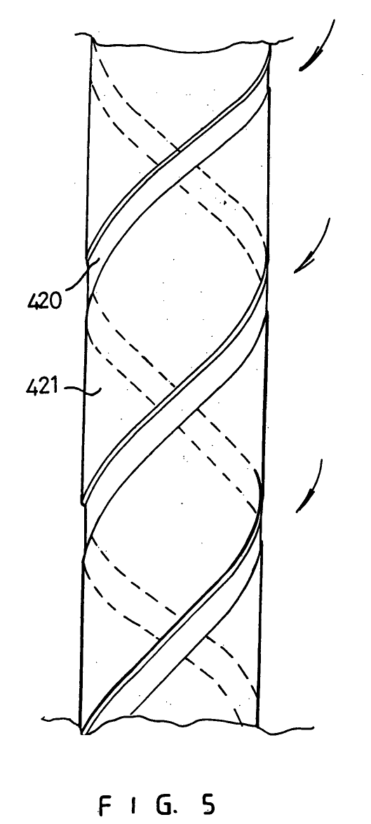

In addition, as shown in FIG. 5, each of the primary stirring strips 421 has a surface formed with a helical groove 420. Preferably, the helical groove 420 of each of the primary stirring strips 421 is extended in a longitudinal direction of each of the primary stirring strips 421.

In operation, the egg beater 4 is rotated by the rotation shaft 11, so that the stirring net 42 is rotated to stir and mix the dough and liquid egg in the mixing barrel 2 as shown in FIG. 1 by the primary stirring strips 421 and the secondary stirring strips 422. Thus, the stirring net 42 is rotated successively to stir and shear the dough to introduce the air into the dough so as to mix the dough with the air, thereby forming a loose and soft blank product for further proceedings.

Accordingly, the air is introduced into the dough rapidly and largely by guide of the helical grooves 420 of the primary stirring strips 421 during rotation of the stirring net 42, so that the air input introduced into the dough is greatly enhanced, thereby decreasing the stirring time of the egg beater 4. In addition, the air is completely introduced into the dough by guide of the helical grooves 420 of the primary stirring strips 421, thereby increasing the quality of the blank product. Further, the helical grooves 420 of the primary stirring strips 421 shear the dough during rotation of the stirring net 42, so that the dough is sheared smoothly and completely, thereby increasing the quality of the cake product made of the blank product. Preferably, the helical groove 420 of each of the primary stirring strips 421 has a width substantially equal to 1 mm and a depth substantially equal to 1 mm so as to obtain the optimum stirring effect. Preferably, the primary stirring strips 421 have overlapping portions 423 (see FIG. 3) combined with each other by soldering, so that the primary stirring strips 421 are combined with rigidly and stably, thereby increasing the lifetime of the egg beater 4.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An egg beater, comprising a seat, and a stirring net mounted on the seat and including a plurality of primary stirring strips and a plurality of secondary stirring strips, wherein:
each of the primary stirring strips has a surface formed with a helical groove.

2. The egg beater in accordance with claim 1, wherein the helical groove of each of the primary stirring strips is extended in a longitudinal direction of each of the primary stirring strips.

3. The egg beater in accordance with claim 1, wherein the helical groove of each of the primary stirring strips has a width substantially equal to 1 mm.

4. The egg beater in accordance with claim 1, wherein the helical groove of each of the primary stirring strips has a depth substantially equal to 1 mm.

5. The egg beater in accordance with claim 1, wherein the primary stirring strips have overlapping portions combined with each other.

6. The egg beater in accordance with claim 5, wherein the overlapping portions of the primary stirring strips are combined with each other by soldering, so that the primary stirring strips are combined with rigidly and stably.
